(19) United States
(12) Patent Application Publication
(10) Pub. No.: US 2026/0163417 A1
(43) Pub. Date: Jun. 11, 2026

(54) DISC MOTOR, FLUID MACHINERY, MOTOR BODY, AND ROTATING ASSEMBLY

(71) Applicant: ZHEJIANG VALUE MECHANICAL & ELECTRICAL PRODUCTS CO., LTD., Taizhou (CN)

(72) Inventors: Yourong JIANG, Taizhou (CN); Lingen WANG, Taizhou (CN)

(21) Appl. No.: 19/183,364

(22) Filed: Apr. 18, 2025

(30) Foreign Application Priority Data
Apr. 26, 2024 (CN) 2024105122032
Apr. 26, 2024 (CN) 2024209031536

(51) Int. Cl. H02K 1/18; H02K 5/10; H02K 7/14

(52) U.S. Cl. CPC H02K 1/182; H02K 5/10; H02K 7/14

(57) ABSTRACT

The present invention relates to the technical field of vacuum fluid machinery, and particularly to a disc motor, fluid machinery, a motor body, and a rotating assembly. A disc motor includes a motor body, including a disc stator and a sealing component, where the sealing component seals the disc stator axially facing an end face of a disc rotor; the disc rotor, with an axial air gap between the disc rotor and the disc stator; a motor shaft, fixedly connected to the disc rotor; and a controller, electrically connected to the disc stator, where the disc rotor, the motor shaft, and the motor body are separately arranged, and the motor shaft and the disc stator are axially staggered. The disc rotor and the motor shaft form a rotating assembly arranged separately from the motor body, which is particularly suitable for sealed connection between the motor shaft and a driven component.

### TECHNICAL FIELD

The present invention relates to the technical field of fluid machinery, and particularly to a disc motor, fluid machinery, a motor body, and a rotating assembly.

### BACKGROUND

Fluid machinery generally refers to fluid transportation devices such as a vacuum pump and a compressor. Fluid media transported by such devices include liquids, gases, and plasma under vacuum conditions. Such devices typically transport a fluid or adjust a pressure by driving a fluid machinery rotor through a motor and a coupling to cause a change in a volume within a fluid machinery stator. To ensure operational reliability, some fluid machinery also uses lubricating oil to lubricate a bearing. However, in common contact sealing, a sealing surface is easy to fail, resulting in medium leakage or pressure disruption. To solve the problem of sealing failure, non-contact sealing is adopted predominantly.

In the field of vacuum pumps, conventional non-contact sealing mainly includes two solutions, namely a sealed coupling and a sealed motor (typically, the fluid machinery and the motor are assembled separately and then installed together). In the first solution of the sealed coupling, a motor shaft and the fluid machinery rotor are connected through a magnetic coupling and a sealing sleeve, resulting in relatively high costs and a relatively large volume due to the additional magnetic coupling and sealing sleeve. In the second solution of the sealed motor, a shielding sleeve typically is provided in the conventional motor, where the shielding sleeve generates heat due to a magnetic field eddy current, resulting in low energy efficiency, and the costs are relatively high due to the difficulty in manufacturing of the shielding sleeve.

The Chinese utility model patent of authorization No. CN209875465U discloses a Roots pump including a vacuum pump and a motor, where the vacuum pump includes a vacuum pump body housing and pump rotor; the motor includes a motor housing, a motor stator, and a motor rotor; a first end of the vacuum pump body housing is connected to a first end of the motor housing in a sealed manner; a rotor shaft is provided in the pump rotor, and an end of the rotor shaft extends into the motor housing and penetrates into the motor rotor; and a second end of the vacuum pump body housing and a second end of the motor housing are each provided with a sealing structure. In the utility model, the vacuum pump body housing and the motor housing are connected to each other in the sealed manner, replacing existing dynamic sealing between the rotor shaft and the vacuum pump body housing with static sealing between the vacuum pump body housing and the motor housing, thereby enhancing a sealing strength of the Roots pump; and the vacuum pump and the motor share the rotor shaft, eliminating the use of a coupling, improving connection stability, and reducing noise and vibration caused by the use of a coupling.

However, the above Chinese utility model patent still has the following problems: 1. it does not disclose how to implement sealing of the motor stator, where if conventional motor potting is used, since a potting mold fails after multiple times of thermal dilatation (the potting mold needs to dilate in a stator bore to prevent glue from remaining in the stator bore), the costs of tooling are high, thereby increasing manufacturing costs; 2. a conventional motor (radial excitation motor) with a rotor located at a radial inner side of a stator is used, which, compared with an axial excitation motor, has a large axial dimension, low efficiency, and a small power density; 3. the shaft and the stator require high coaxiality (it is required to ensure an radial air gap between the stator and the rotor), making machining and assembly relatively difficult; 4. motor overload protection needs to be provided separate; and 5. machining and assembly of dual-end/dual-motor driving are relatively difficult.

### SUMMARY

In view of the defects in a sealing structure between a motor and a fluid machinery body of an existing fluid machinery, the present invention provides a disc motor, so as to improve the sealing structure. The present invention also provides fluid machinery adopting the disc motor, a motor body of the disc motor, and a rotating assembly.

In order to achieve the above purpose, the present invention adopts the following technical solution: a disc motor, including:
a motor body, including a disc stator and a sealing component, wherein the sealing component seals the disc stator axially facing an end face of a disc rotor;
the disc rotor, with an axial air gap between the disc rotor and the disc stator;
a motor shaft, fixedly connected to the disc rotor; and
a controller, electrically connected to the disc stator,
wherein the disc rotor, the motor shaft, and the motor body are separately arranged, and the motor shaft and the disc stator are axially staggered.

Compared with the existing disc motor with a motor shaft penetrating through a disc stator, the disc motor of the present invention has the motor shaft and the disc stator axially staggered, so that the disc rotor and the motor shaft form the rotating assembly arranged separately from the motor body. The motor body includes the disc stator and the sealing component that seals the disc stator axially facing the end face of the disc rotor. When the disc motor is applied to a device such as fluid machinery, static sealing may be adopted between the motor body and the fluid machinery casing. The motor shaft may be the same shaft as the fluid machinery shaft or be connected to the fluid machinery shaft via the coupling, eliminating the need to consider sealing between the motor shaft and the fluid machinery shaft, avoiding dynamic sealing between the rotor shaft and the fluid machinery casing, thereby ensuring sealing performance. Compared with the most conventional radial flux motor, the disc motor (also referred to as an axial flux motor) has many advantages over the conventional radial excitation motor, such as larger torque (among motors of a specific volume, an axial flux permanent magnet motor typically can provide larger torque), a more compact structure (an axial length is significantly reduced), a smaller weight, and higher efficiency, thereby facilitating maintenance. In the disc motor of the present invention, although the problem such as the axial air gap remains unsolved, separating the motor body from the disc rotor and the motor shaft has many advantages, particularly when applied to sealed connection between the motor shaft and a driven component.

As an improvement, the sealing component is integrally connected to the disc stator by means of potting, a housing is fixedly connected to an exterior of the disc stator, and sealing is present between the housing and the sealing component. The machining in potting is less difficult.

As an improvement, the sealing component is integrally connected to the disc stator by means of injection molding, the sealing component forms a housing of the disc motor or a housing is provided outside the sealing component, and sealing is present between the housing and the sealing component. The sealing component is integrally connected to the disc stator by means of injection molding. The injection-molded sealing component has a relatively good structural strength. The sealing component can directly form the housing of the disc motor, eliminating the need to provide the housing separately (of course, for other considerations, the housing may also be provided separately outside the sealing component).

As an improvement, the sealing component seals the entire disc stator therein. When a housing independent of the sealing component is provided separately, the sealing component can seal only the end face of the disc stator, thereby reducing the amount of a material used by the sealing component and lowering the process difficulty; and sealing for other parts of the disc stator is implemented through sealing between the sealing component and the housing.

As an improvement, the disc motor includes two motor bodies and two disc rotors, both of the motor bodies and both of the disc rotors are located at two ends of the motor shaft, and the disc stators of the two motor bodies are electrically connected to the same controller, making it possible to implement dual-end driving.

There is provided fluid machinery, including a fluid machinery body and a disc motor, where the fluid machinery body includes a fluid machinery casing and a fluid machinery rotor, the disc motor is the disc motor described above, and the disc motor includes a housing connected to the fluid machinery casing in a sealed manner.

The fluid machinery of the present invention adopts the disc motor and has various advantages of the disc motor, where the motor body and the motor shaft of disc motors are separately arranged and axially staggered, static sealing may be adopted between the motor body and the fluid machinery casing, the motor shaft may be the same shaft as a fluid machinery shaft or be connected to the fluid machinery shaft via a coupling, eliminating the need to consider sealing between the motor shaft and the fluid machinery shaft, avoiding a dynamic sealing structure between the rotor shaft and the fluid machinery casing, thereby ensuring sealing performance.

As an improvement of the fluid machinery, the fluid machinery rotor includes a fluid machinery shaft, and the fluid machinery shaft also forms the motor shaft.

As another improvement of the fluid machinery, the fluid machinery shaft is connected to the motor shaft via a coupling, where the coupling does not have to be a sealed coupling.

As an improvement of the fluid machinery, the housing is connected to the fluid machinery casing in the sealed manner via a sealing ring and an axial threaded connector; and a radial positioning structure is formed between the fluid machinery casing and the housing.

There is provided a motor body for a disc motor, where the disc motor is the disc motor described above.

There is provided a rotating assembly for a disc motor, where the disc motor is the disc motor described above, the rotating assembly includes the disc rotor and the motor shaft, and the motor shaft is formed by a fluid machinery shaft of fluid machinery.

### BRIEF DESCRIPTION OF THE DRAWINGS

FIG. 1 is a sectional view of fluid machinery of embodiment I of the present invention.

FIG. 2 is a sectional view of a disc motor of the fluid machinery of embodiment I of the present invention.

FIG. 3 is a sectional view of fluid machinery of embodiment II of the present invention.

FIG. 4 is a sectional view of a disc motor of the fluid machinery of embodiment II of the present invention.

FIG. 5 is a sectional view of fluid machinery of embodiment III of the present invention.

FIG. 6 is a sectional view of fluid machinery of embodiment IV of the present invention.

In which: 1—fluid machinery body; 11—fluid machinery casing; 12—fluid machinery rotor; 121—fluid machinery shaft; 13—bearing; 14—gear;
2—disc motor; 21—motor body; 211—disc stator; 212—sealing component; 22—disc rotor; 221—mounting disc; 222—magnetic steel; 23—motor shaft; 24—controller.

### DETAILED DESCRIPTION OF EMBODIMENTS

The technical solutions of the embodiments of the present invention and creation are explained and illustrated below, but the following embodiments are merely preferred embodiments of the present invention and creation, rather than all of the embodiments. Based on the embodiments in the implementations, all other embodiments obtained by those skilled in the art without the exercise of inventive effort shall fall into the scope of protection of the present invention and creation.

### Embodiment I

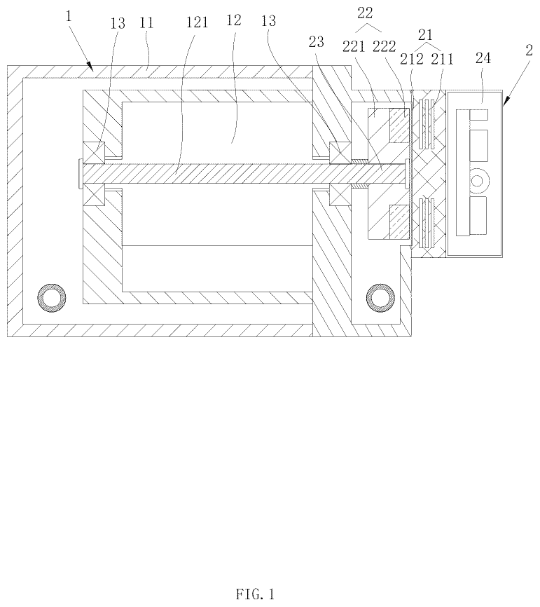

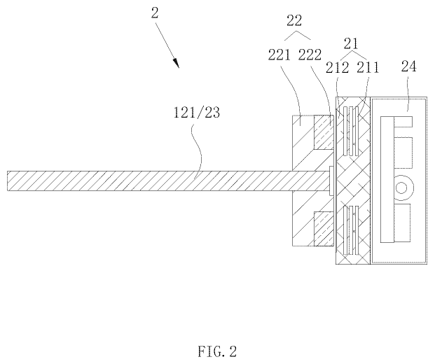

Referring to FIGS. 1 and 2, fluid machinery of embodiment I of the present invention includes a fluid machinery body 1 and a disc motor 2, where the fluid machinery body 1 includes a fluid machinery casing 11 and a fluid machinery rotor 12, and the disc motor 2 includes:
a motor body 21, including a disc stator 211 and a sealing component 212, where the sealing component 212 seals the disc stator 211 axially facing an end face of a disc rotor 22;
the disc rotor 22, with an axial air gap between the disc rotor and the disc stator 211;
a motor shaft 23, fixedly connected to the disc rotor 22; and
a controller 24, electrically connected to the disc stator 211,
where the disc rotor 22, the motor shaft 23, and the motor body 21 are separately arranged, and the motor shaft 23 and the disc stator 211 are axially staggered.

In the prior art, the most commonly used dual-stator, single-rotor disc motor has a motor shaft penetrating through a stator and then being fixedly connected to a rotor, that is, axial projections (a plane where a projection coincides with an axis) of the disc stator 2 and the motor shaft have an overlap segment. In this embodiment, the motor shaft 23 and the disc stator 211 are axially staggered, that is, axial projections (a plane where a projection coincides with an axis) of the motor shaft 23, the disc rotor 22. and the disc stator 211 have no overlap segment.

In this embodiment, the sealing component 212 is integrally connected to the disc stator 211 by means of injection molding, the sealing component 212 forms a housing of the disc motor 2, and sealing is present between the housing and the sealing component 212. The sealing component 212 is integrally connected to the disc stator 211 by means of injection molding. The injection-molded sealing component 212 has a relatively good structural strength. The sealing component 212 can directly form the housing of the disc motor 2, eliminating the need to separately provide the housing.

In this embodiment, the sealing component 212 seals the entire disc stator 211 therein.

In this embodiment, the housing is connected to the fluid machinery casing 11 in the sealed manner via a sealing ring and an axial threaded connector. A sealing structure of the housing and the fluid machinery casing 11 is not shown in the figure, and reference may be made to the prior art.

In other embodiments, when a housing independent of the sealing component 212 is provided separately, the sealing component 212 can seal only the end face of the disc stator 211, thereby reducing the amount of a material used by the sealing component 212 and lowering the process difficulty; and sealing for other parts of the disc stator 211 is implemented through sealing between the sealing component 212 and the housing.

In other embodiments, the sealing component 212 is integrally connected to the disc stator 211 by means of potting, a housing is fixedly connected to an exterior of the disc stator 211, and sealing is present between the housing and the sealing component 212. The machining in potting is easy.

In this embodiment, a radial positioning structure is formed between the fluid machinery casing 11 and the housing. The radial positioning structure may be a positioning hole and a positioning pin, which are not shown in the figure, and reference may be made to the prior art.

In this embodiment, the fluid machinery rotor 12 includes a fluid machinery shaft 121, and the fluid machinery shaft 121 also forms the motor shaft 23. That is, the fluid machinery shaft 121 and the motor shaft 23 are the same integral shaft, or the same shaft part serves as both the fluid machinery shaft 121 and the motor shaft 23, or the fluid machinery shaft 121 extends out of the fluid machinery casing 11 and then forms the motor shaft 23 that is fixedly connected to the disc rotor 22 of the disc motor 2.

In other embodiments, the fluid machinery shaft 121 is connected to the motor shaft 23 via a coupling.

In this embodiment, the fluid machinery body 1 further includes a fluid machinery stator and two bearings 13 supporting the fluid machinery shaft 121, where the bearings 13 are provided in the fluid machinery stators of the fluid machinery body 1. A shaft seal is provided on an axial inner side of the bearing 13, and implements static sealing between the fluid machinery shaft 121 and the fluid machinery stator (for the sealing here, reference may be made to the prior art, e.g., a piston ring).

In this embodiment, an oil tank is formed between the fluid machinery casing 11 and the fluid machinery stator. A water-cooled assembly is provided in the oil tank.

In this embodiment, medium inlet and outlet channels on the fluid machinery stator are not shown.

In this embodiment, the fluid machinery is a single-stage rotary vane pump.

In other embodiments, the fluid machinery may also be a two-stage rotary vane pump, a multi-stage dry pump, a Roots pump, a Roots screw combined pump, etc., in which case only a corresponding change in the pump body is required.

In other embodiments, the fluid machinery may also be a compressor.

In this embodiment, the drawings are illustration of a principle only. For the control principle of the disc motor, reference may be made to the prior art.

Compared with the existing disc motor with a motor shaft penetrating through a disc stator, the disc motor 2 of the fluid machinery of this embodiment of the present invention has the motor shaft 23 and the disc stator 211 axially staggered, so that the disc rotor 22 and the motor shaft 23 form the rotating assembly arranged separately from the motor body 21. The motor body 21 includes the disc stator 211 and the sealing component 212 that seals the disc stator 211 axially facing the end face of the disc rotor 22. The motor shaft 23 is the same shaft as the fluid machinery shaft 121, omitting the coupling. Compared with the most conventional radial flux motor, the disc motor 2 (also referred to as an axial flux motor) has many advantages, such as larger torque (among motors of a specific volume, an axial flux permanent magnet motor typically can provide larger torque), a more compact structure (an axial length is significantly reduced), a smaller weight, and higher efficiency, so that the motor body 21 can be easily separated from the fluid machinery casing 11, thereby facilitating maintenance. Compared with the radial flux motor that requires insertion of the fluid machinery shaft and the rotor into the stator and keeping of a radial air gap between the rotor and the stator, the disc motor of the this embodiment only need to keep an axial air gap, and has the motor body 21 easier to disassemble and assemble; and the motor will not be damaged when it is overloaded, eliminating the need to provide overload protection.

### Embodiment II

Embodiment II differs from embodiment I in that disc rotors 22 are provided at both ends of the fluid machinery shaft 121.

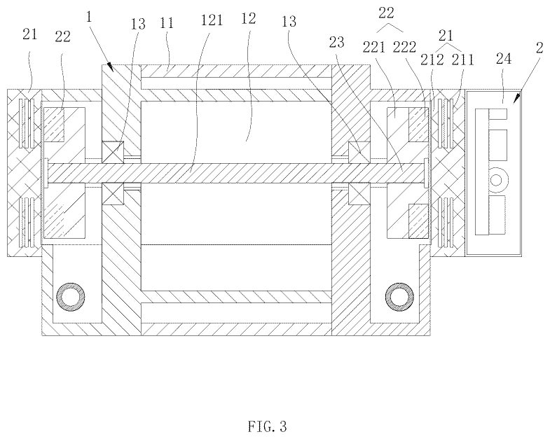

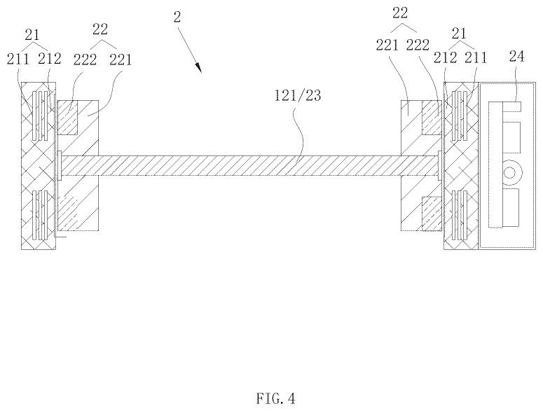

Referring to FIGS. 3 and 4, embodiment II of the present invention provides fluid machinery, where the disc motor 2 includes two motor bodies 21 and two disc rotors 22, both of the motor bodies 21 and both of the disc rotors 22 are located at two ends of the motor shaft 23, and the disc stators 211 of the two motor bodies 21 are electrically connected to the same controller 24, making it possible to implement dual-end synchronous driving.

For a sealing connection structure of the fluid machinery casing 11, the fluid machinery stator, etc. reference may be made to the prior art, e.g., using a sealing ring and a threaded connector.

For other related description, reference may be made to embodiment I.

### Embodiment III

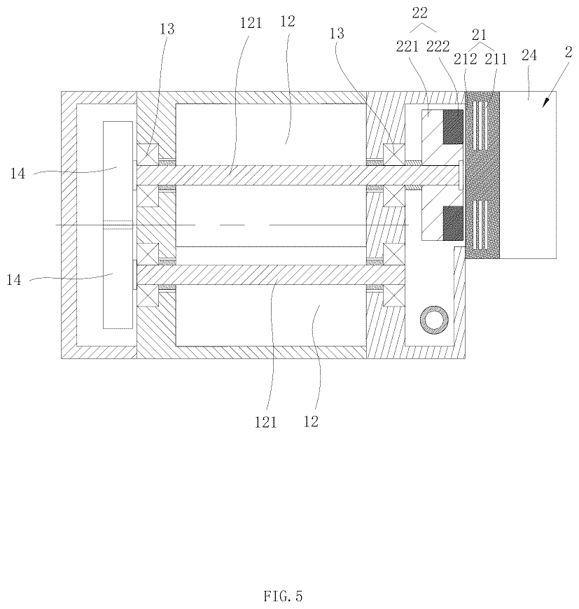

Referring to FIG. 5, embodiment III of the present invention provides fluid machinery, which is a Roots pump and has two pump rotors 12, where the two pump rotors 12 are engaged by gears 14 at an end away from the disc motor 2.

For other related description, reference may be made to embodiment I.

### Embodiment IV

Embodiment IV differs from embodiment III in that two disc motors 2 are provided.

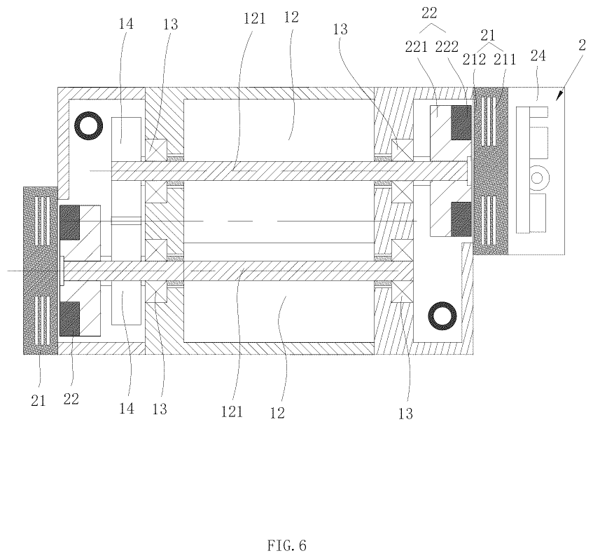

Referring to FIG. 6, embodiment IV of the present invention provides fluid machinery, which is a Roots pump and has two fluid machinery rotors 12, where the two fluid machinery rotors 12 are engaged by gears 14 at an end, disc rotors 22 and disc stators 211 are provided at different ends of the two fluid machinery rotors 12, the two disc motors 2 share a controller 24, and the two disc motors 2 are driven synchronously.

For other related description, reference may be made to embodiment I.

This embodiment of the present invention also provides a disc motor 2, where the disc motor 2 is the disc motor 2 described above. The disc motor 2 is particularly suitable for fluid machinery and may also be used to drive other devices.

This embodiment of the present invention also provides a motor body 21 for a disc motor 2, where the disc motor 2 is the disc motor 2 described above.

This embodiment of the present invention also provides a rotating assembly for a disc motor 2, where the disc motor 2 is the disc motor 2 described above, and the rotating assembly includes the disc rotor 22 and the motor shaft 23.

Only the specific implementations of the present invention creation are described above, but the scope of protection of the present invention creation is not limited thereto. A person skilled in the art should understand that the present invention creation includes, but is not limited to, the content described in the above specific implementations. Any modifications that do not deviate from the functional and structural principles of the present invention creation shall be included in the scope of the claims.

1. A disc motor, comprising:
a motor body, comprising a disc stator and a sealing component, wherein the sealing component seals the disc stator axially facing an end face of a disc rotor;
the disc rotor, with an axial air gap between the disc rotor and the disc stator; a motor shaft, fixedly connected to the disc rotor; and
a controller, electrically connected to the disc stator,
wherein the disc rotor, the motor shaft, and the motor body are separately arranged, and the motor shaft and the disc stator are axially staggered.

2. The disc motor according to claim 1, wherein the sealing component is integrally connected to the disc stator by means of potting, a housing is fixedly connected to an exterior of the disc stator, and sealing is present between the housing and the sealing component.

3. The disc motor according to claim 1, wherein the sealing component is integrally connected to the disc stator by means of injection molding, the sealing component forms a housing of the disc motor or a housing is provided outside the sealing component, and sealing is present between the housing and the sealing component.

4. The disc motor according to claim 1, wherein the sealing component seals the entire disc stator therein.

5. The disc motor according to claim 1, wherein the disc motor comprises two motor bodies and two disc rotors, both of the motor bodies and both of the disc rotors are located at two ends of the motor shaft, and the disc stators of the two motor bodies are electrically connected to the same controller.

6. Fluid machinery, comprising a fluid machinery body and a disc motor, the fluid machinery body comprising a fluid machinery casing and a fluid machinery rotor, wherein the disc motor is the disc motor according to claim 1, and the disc motor comprises a housing connected to the fluid machinery casing in a sealed manner.

7. The fluid machinery according to claim 6, wherein the fluid machinery rotor comprises a fluid machinery shaft, and the fluid machinery shaft also forms the motor shaft or is connected to the motor shaft via a coupling.

8. The fluid machinery according to claim 6, wherein the housing is connected to the fluid machinery casing in the sealed manner via a sealing ring and an axial threaded connector; and a radial positioning structure is formed between the fluid machinery casing and the housing.

9. A motor body for a disc motor, wherein the disc motor is the disc motor according to claim 1.

10. A rotating assembly for a disc motor, wherein the disc motor is the disc motor according to claim 1, the rotating assembly comprises the disc rotor and the motor shaft, and the motor shaft is formed by a fluid machinery shaft of fluid machinery.
